(19) United States
(12) Patent Application Publication
(10) Pub. No.: US 2013/0134368 A1
(43) Pub. Date: May 30, 2013

(54) ORGANIC-INORGANIC COMPOSITE MATERIAL AND PRODUCTION PROCESS THEREOF, AND OPTICAL ELEMENT

(71) Applicant: Keiichiro Tsubaki, Tokyo (JP)

(72) Inventor: Keiichiro Tsubaki, Tokyo (JP)

(73) Assignee: CANON KABUSHIKI KAISHA, Tokyo (JP)

(21) Appl. No.: 13/518,772

(22) PCT Filed: Dec. 10, 2010
(86) PCT No.: PCT/JP2010/072722

§ 371 Date: Jun. 22, 2012

(30) Foreign Application Priority Data
Jan. 14, 2010 (JP) 2010-006249

(51) Int. Cl. G02B 1/04

(52) U.S. Cl. CPC G02B 1/04
USPC 252/582; 526/194

(57) ABSTRACT

The invention provides an organic-inorganic composite material having a sufficient transparency and a low coefficient of linear expansion, an optical element using the same and a production process thereof. The organic-inorganic composite material has at least one polymer compound and at least one inorganic oxide having a three-dimensional network structure, wherein the polymer compound has a three-dimensional network structure and is covalently bonded to the inorganic oxide, and the haze value of the organic-inorganic composite material in terms of a thickness of 5 mm is 10% or less.

### TECHNICAL FIELD

The present invention relates to an organic-inorganic composite material and a production process thereof, and an optical element.

### BACKGROUND ART

Resinous optical materials have come to be used in place of optical glass material because of the advantage of being low in specific gravity, capable of reducing the weight and excellent in impact resistance. On the other hand, the resinous optical materials have a relatively high coefficient of linear expansion and thus involve a problem of dimensional stability when used as optical materials.

In order to improve the dimensional stability of a resinous optical material, an inorganic material is added to the resinous optical material, thereby obtaining an organic-inorganic composite material having a relatively low coefficient of linear expansion. Glass fiber or talc is often used as the inorganic material added. However, it is necessary that a difference in refractive index between the inorganic material and the resin is made as small as possible for making the transparency of the resulting optical material better, i.e. making the haze value thereof lower. Therefore, the usable combination of the inorganic material and the resin is limited. In order to solve this problem, a method of making the haze value low by adding inorganic nano particles is also investigated. However, the inorganic nano particles are difficult to be uniformly dispersed in the resinous optical material, and thus, the resulting organic-inorganic composite material comes to have a high haze value.

For example, Japanese Patent No. 02574049 (PTL 1) describes an organic-inorganic composite transparent homogenizate characterized in that an amide-bond-containing non-reactive polymer composed of a polyoxazoline polymer, polyethylene-imine polymer or starburst dendrimer is uniformly dispersed in a three-dimensional fine network structure of a metal oxide formed by a sol-gel method.

Japanese Patent Application Laid-Open No. 2006-182899 (PTL 2) describes a polycarbonate composition containing a polycarbonate resin, a silicone and an inorganic compound with the silicone forming a three-dimensional network in the polycarbonate resin.

As described above, an organic-inorganic composite material low in both haze value and coefficient of linear expansion has been required.

### CITATION LIST

### Patent Literature

PTL 1: Japanese Patent No. 02574049
PTL 2: Japanese Patent Application Laid-Open No. 2006-182899

### SUMMARY OF INVENTION

### Technical Problem

It is an object of the present invention to provide an organic-inorganic composite material low in both haze value and coefficient of linear expansion and a production process thereof, and an optical element.

### Solution to Problem

In a first aspect of the present invention, there is provided an organic-inorganic composite material comprising at least one polymer compound and at least one inorganic oxide having a three-dimensional network structure, wherein the polymer compound has a three-dimensional network structure and is covalently bonded to the inorganic oxide, and the haze value of the organic-inorganic composite material in terms of a thickness of 5 mm is 10% or less.

In a second aspect of the present invention, there is provided a production process of an organic-inorganic composite material, which comprises a first step of providing an inorganic oxide having a three-dimensional network structure into which a reactive group has been introduced and a second step of polymerizing a reactive compound to obtain a polymer compound having a three-dimensional network structure as well as causing the reactive compound to react with the reactive group to covalently bond the polymer compound to the inorganic oxide.

In a third aspect of the present invention, there is provided a production process of an organic-inorganic composite material, which comprises a first step of providing an inorganic oxide having a three-dimensional network structure into which a reactive group has been introduced, a second step of causing a reactive compound to react with the reactive group to covalently bond the reactive compound to the inorganic oxide, and a third step of polymerizing the reactive compound to obtain a polymer compound having a three-dimensional network structure.

In a fourth aspect of the present invention, there is provided a production process of an organic-inorganic composite material, which comprises a first step of providing an inorganic oxide having a three-dimensional network structure into which a reactive group has been introduced, a second step of polymerizing a reactive compound to obtain a polymer compound having a three-dimensional network structure, and a third step of causing the reactive compound to react with the reactive group to covalently bond the polymer compound to the inorganic oxide.

### Advantageous Effects of Invention

According to the organic-inorganic composite material of the present invention, the polymer compound is covalently bonded to the inorganic oxide, so that an organic-inorganic composite material low in both haze value and coefficient of linear expansion has been able to be realized.

Further features of the present invention will become apparent from the following description of exemplary embodiments with reference to the attached drawings.

### BRIEF DESCRIPTION OF DRAWINGS

FIGS. 1A, 1B and 1C are drawings for explaining a polymerizable compound, a polymer compound and a monomer unit, respectively, in a first embodiment.

FIGS. 2A, 2B, 2C and 2D are drawings for explaining a specific example of a method for evaluating the presence of a covalent bond between a polymer compound and an inorganic oxide.

### DESCRIPTION OF EMBODIMENTS

Embodiments of the present invention will now be described. However, the organic-inorganic composite materials and the production processes thereof, and optical elements according to the present invention are not limited thereto.

The present inventor has carried out an investigation as to the material disclosed in PTL 1. As a result, it has been considered that in the organic-inorganic composite transparent homogenizate described in PTL 1, the amide-bond-containing non-reactive polymer that is an organic component and the metal oxide that is an inorganic component are not covalently bonded to each other, and the effect to lower a coefficient of linear expansion is limited. It has also been considered that the polycarbonate compound described in PTL 2 is high in haze value.

### First Embodiment

The organic-inorganic composite material according to a first embodiment of the present invention is an organic-inorganic composite material containing at least one polymer compound having a three-dimensional network structure and at least one inorganic oxide having a three-dimensional network structure, and the polymer compound is covalently bonded to the inorganic oxide, and the haze value of the organic-inorganic composite material in terms of a thickness of 5 mm is 10% or less.

In the organic-inorganic composite material (hereinafter may be referred to as “composite material” merely) according to this embodiment, the inorganic oxide having a low coefficient of linear expansion and a three-dimensional network structure is covalently bonded to the polymer compound having a high coefficient of linear expansion compared with the inorganic oxide and having a three-dimensional network structure. Therefore, it is supposed that the mobility of the polymer compound is strongly restrained not only at an interface between the organic and inorganic components but also at each bonding point, and then the coefficient of linear expansion is effectively lowered. Accordingly, it is supposed that the movement of the polymer compound is more strongly restrained as the bonding sites increase, and so the coefficient of linear expansion is more lowered as the covalently bonding sites increase. Thus, the polymer compound according to this embodiment can be expected to have an effect due to the combination with the inorganic oxide irrespective of the coefficient of linear expansion inherent in the polymer compound.

Since both the polymer compound and the inorganic oxide according to this embodiment have a three-dimensional network structure, the organic-inorganic composite material has a high transparency, i.e., low in haze value. The reason why the composite material according to this embodiment has high transparency is considered to be as follows. Compatibility between an organic compound and an inorganic compound is generally low, and it is thus said that a uniform composite, to say nothing of a composite having high transparency, is hard to be provided by mere mixing. In this embodiment, the polymer compound having the three-dimensional network structure and the inorganic oxide having the three-dimensional network structure are covalently bonded to each other. It is considered that it is thereby possible to let both components have compatibility at a molecular level, and high transparency is achieved. It is thus considered that although the organic and inorganic components are naturally limited to those each having a specific structure for letting both components have compatibility, high transparency can be achieved without particularly limiting the structures in the present invention.

### Polymer Compound

The polymer compound contained in the organic-inorganic composite material (hereinafter may be referred to as “composite material”) according to this embodiment means a polymer of a polymerizable compound. Examples of the polymer compound include acrylic resins, styrene resins, cyclic polyolefin resins, epoxy resins, polycarbonate resins, polyester resins, polyether resins and polyamide resins. However, the polymer compound is not limited thereto. Examples of the acrylic resins include polymers of (meth)acrylic monomers, such as polymethyl methacrylate and polybenzyl methacrylate.

The polymer compound according to this embodiment may contain only any one of the above-exemplified polymer compounds or contain a plurality thereof. When a plurality of the polymer compounds is used, a three-dimensional network structure composed of the plurality of the polymer compounds is formed.

In addition, the above-exemplified polymer compounds may each be composed of a plurality of monomer units. In other words, they may be random copolymers, alternating copolymers, block copolymers, graft copolymers or the like. Examples of copolymers include styrene-acrylic copolymers. Here, the monomer unit means a monomer making up the polymer compound.

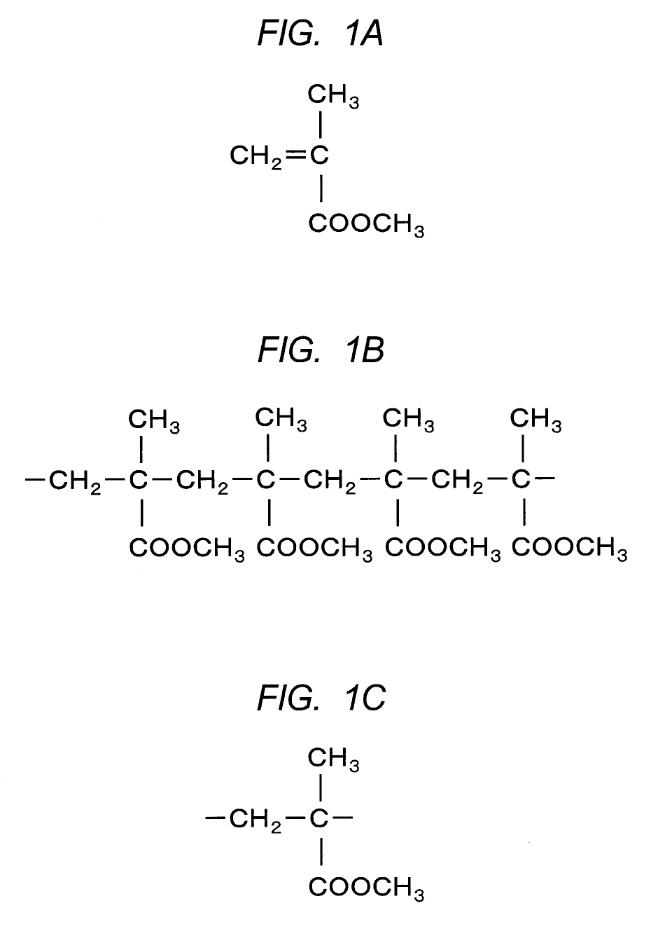

A polymerizable compound, a polymer compound and a monomer unit in this embodiment are specifically explained with reference to FIGS. 1A, 1B and 1C. A polymer of methyl methacrylate (FIG. 1A) that is the polymerizable compound is polymethyl methacrylate (FIG. 1B). The monomer unit of polymethyl methacrylate is illustrated in FIG. 1C.

The polymer compound according to this embodiment is favorably a vinyl polymer compound. The vinyl polymer compound is the generic name of a polymer of a vinyl-group-containing monomer, and examples of the vinyl polymer compound include the acrylic resins and styrene resins.

The three-dimensional network structure of the polymer compound according to this embodiment means such a network structure that the component monomer units are three-dimensionally connected to one another in an x-axis direction, a y-axis direction and a z-axis direction by a chemical bond and an intermolecular interaction. When a polymer compound takes a three-dimensional network structure, its coefficient of linear expansion is lowered. In the three-dimensional network structure of the polymer compound according to this embodiment, the primary bonding thereof is favorably a covalent bond such that the effect to lower the coefficient of linear expansion can be expected.

As for the primary bonding, it is generally known that a three-dimensional network structure is formed by, for example, causing a plurality of reactive functional groups to be contained in a polymer compound to react them or by causing a multifunctional monomer to be contained between a component monomer unit and another component monomer unit. The component monomer units are selected according to necessary properties, whereby the coefficient of linear expansion of the three-dimensional network structure of the polymer compound formed can be reduced lower.

When the polymer compound is an acrylic resin, as examples of the polymerizable compound, may be mentioned methyl (meth)acrylate, ethyl (meth)acrylate, n-butyl (meth)acrylate, isobutyl (meth)acrylate, t-butyl (meth)acrylate, 2-ethylhexyl (meth)acrylate, octyl (meth)acrylate, lauryl (meth)acrylate, stearyl (meth)acrylate, cyclohexyl (meth)acrylate, isobonyl (meth)acrylate, 2-hydroxyethyl (meth)acrylate, glycidyl (meth)acrylate, tetrahydrofurfuryl (meth)acrylate, phenylglycidyl (meth)acrylate, dimethylaminomethyl (meth)acrylate, phenylcellosolve (meth)acrylate, dicyclopentenyl (meth)acrylate, biphenyl (meth)acrylate, 2-hydroxyethyl (meth)acryloyl phosphate, phenyl (meth)acrylate, phenoxyethyl (meth)acrylate, phenoxypropyl (meth)acrylate, benzyl (meth)acrylate, trifluoroethyl (meth)acrylate, tetrafluoropropyl (meth)acrylate, ethylene glycol di(meth)acrylate, diethylene glycol di(meth)acrylate, triethylene glycol di(meth)acrylate, tetraethylene glycol di(meth)acrylate, nonaethylene glycol di(meth)acrylate, 1,3-butylene glycol di(meth)acrylate, 1,4-butanediol di(meth)acrylate, dimethyloltricyclodecane di(meth)acrylate, trimethylolpropane tri(meth)acrylate, neopentyl glycol di(meth)acrylate, 1,6-hexamethylene di(meth)acrylate, hydroxypivalic acid ester neopentyl glycol di(meth)acrylate, pentaerythritol tri(meth)acrylate, pentaerythritol tetra(meth)acrylate, ditrimethylolpropane tetraacrylate, dipentaerythritol tetra(meth)acrylate, dipentaerythritol penta(meth)acrylate, dipentaerythritol hexa(meth)acrylate and tris(meth)acryloxyethyl isocyanulate.

In the case of a styrene resin, as examples of the polymerizable compound, may be mentioned styrene, α-methylstyrene, p-methylstyrene, vinyltoluene, vinylxylene, trimethylstyrene, butylstyrene, chlorostyrene, dichlorostyrene, bromostyrene, p-hydroxystyrene, methoxystyrene, vinylnaphthalene, vinylanthracene and divinylbenzene.

In order to obtain a polymer compound having a three-dimensional network structure in this embodiment, a multifunctional monomer is favorably used as the polymerizable compound. No particular limitation is imposed on the multifunctional monomer. However, trimethylolpropane triacrylate is favorable.

### Inorganic Oxide

In the composite material according to this embodiment, a common metal or nonmetal inorganic oxide may be used as the inorganic oxide for forming the three-dimensional network structure of the inorganic oxide. The inorganic oxide according to this embodiment favorably has optical properties suitable for optical elements, and specific examples of such an inorganic oxide include silicon dioxide, titanium oxide, zirconium oxide and aluminum oxide. Silicon dioxide is more favorable as the inorganic oxide according to this embodiment. The three-dimensional network structure is favorably a fine structure for lowering the haze value of the composite material according to this embodiment. In order to efficiently form the fine three-dimensional network structure of the inorganic oxide, hydrolysis-polycondensation by a sol-gel reaction of an inorganic alkoxide is favorably conducted. As the inorganic alkoxide used in this sol-gel reaction, may be used one or more compounds.

The three-dimensional network structure of the inorganic oxide according to this embodiment means such a network structure that other atoms than oxygen of the inorganic oxide are three-dimensionally connected to one another in an x-axis direction, a y-axis direction and a z-axis direction through the oxygen. For example, when the inorganic oxide is silicon dioxide, the three-dimensional network structure is a network structure in which the structure “Si—O—Si—O—Si . . . ” is three-dimensionally distributed.

Since the inorganic oxide according to this embodiment is favorably silicon dioxide, a tetrafunctional silane compound such as tetramethoxysilane (TMOS) or tetraethoxysilane (TEOS), an alkyl-substituted trifunctional silane such as ethyltriethoxysilane or phenyltriethoxysilane, or methacryloxypropyltrimethoxy-silane containing a vinyl group, or a bifunctional silane such as diethyldiethoxysilane or diphenyl-diethoxysilane is favorable as a corresponding alkoxide. These alkoxides may be used either singly or in any combination thereof. When the alkoxides are used in combination, the hydrolyzability and condensability thereof greatly vary according to the kinds of the alkyl groups. In such a case, the alkoxides are separately hydrolyzed in advance, and the resultant hydrolyzates are mixed and condensed, whereby the reactivity can be improved. In this embodiment, a plurality of inorganic oxides may be used, so that three-dimensional network structures of the plurality of the inorganic oxides may be formed.

Since the sol-gel reaction permits easily forming an fine and uniform network structure of a nanometer order, the reaction is favorable as a method for forming the three-dimensional network structure of the inorganic oxide according to this embodiment. In the present invention, the forming method is not limited thereto so far as the fine and uniform network structure of the nanometer order is provided as described above. Other methods than the sol-gel reaction include, for example, a method of forming a micro phase separation structure by using an organic-inorganic block copolymer in which the inorganic component forms a domain, fixing the structure, and then removing the organic component through baking, etching, and the like.

### Organic-Inorganic Composite Material

In the organic-inorganic composite material according to this embodiment, the three-dimensional network structure of the polymer compound and the three-dimensional network structure of the inorganic oxide are bonded by a covalent bond. The covalent bond is distributed throughout the three-dimensional network structure, and the effect to lower the coefficient of linear expansion becomes great as the quantity of bond increases. The mechanism with which the coefficient of linear expansion is lowered is not elucidated in detail. However, the following mechanism is supposed. It is generally known that when an inorganic oxide having a low coefficient of linear expansion is added to a polymer compound having a high coefficient of linear expansion, the mobility of the polymer compound is restrained at an interface between them and thus the whole coefficient of linear expansion is lowered.

In this embodiment, the coefficient of linear expansion is an average value of coefficients of linear expansion from 20° C. to 60° C. and can be measured by a thermomechanical analyzer (TMA) or the like.

In this embodiment, the crosslinking density of the three-dimensional network structure and the presence of the network structure of the three-dimensional network may be determined by using a publicly known evaluation techniques which will be described subsequently. Examples thereof include methods such as direct observation through an electron microscope or the like, a hydromechanical evaluation method using a light scattering method, evaluation of viscoelasticity behavior by a Rheometer or the like, and measurement of relaxation time by NMR such as 1H-NMR or Si-NMR, or the like.

In this embodiment, the covalent bond between the polymer compound and the inorganic oxide can be evaluated and quantified by a publicly known spectrometric techniques, such as IR, Raman spectrometry, and NMR such as 1H-NMR or Si-NMR, before and after the reaction.

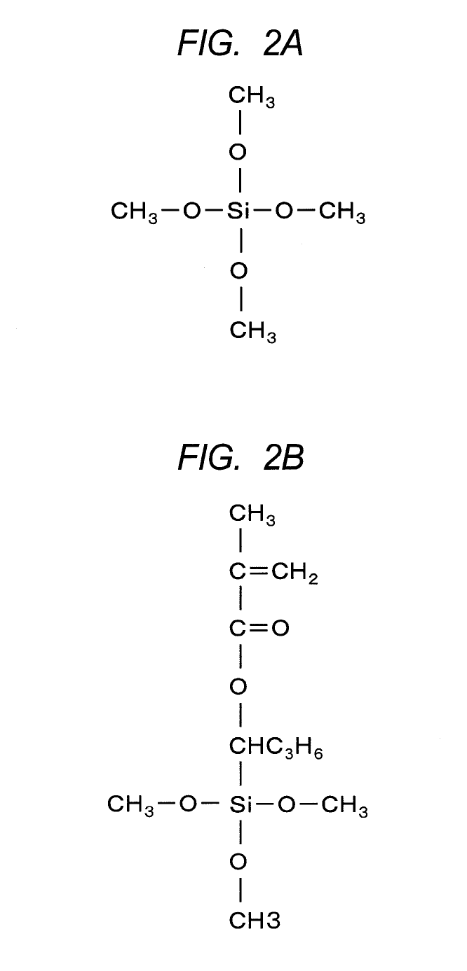

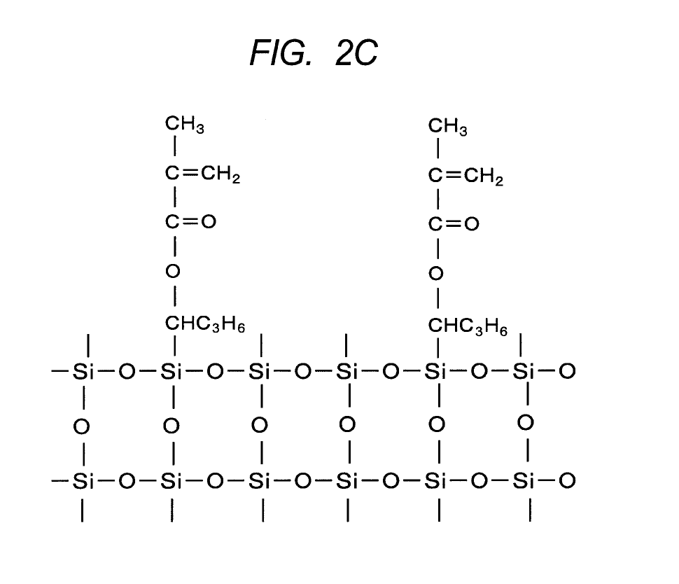

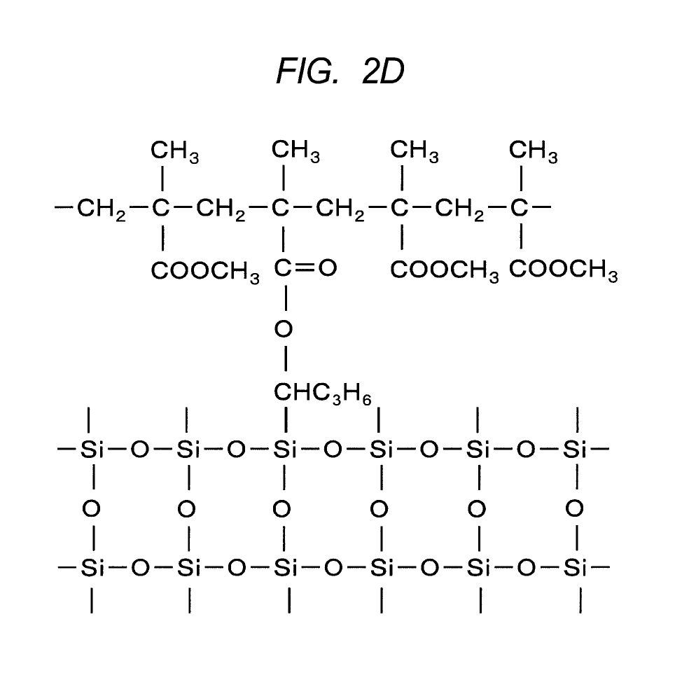

A specific example of a method for evaluating the presence of the covalent bond between the polymer compound and the inorganic oxide is explained with reference to FIGS. 2A to 2D. For example, when tetramethoxysilane (FIG. 2A) and 3-methacryloxypropyl-trimethoxysilane (FIG. 2B) are gelled by a sol-gel reaction, it is supposed that silica gel having a vinyl group illustrated in FIG. 2C is obtained. When the resultant silica gel is subjected to measurement by 1H-NMR, a peak derived from the vinyl group is measured. When the resultant silica gel is then impregnated with methyl methacrylate and a polymerization initiator to completely replace the solvent in the gel, and polymerization is then conducted, an organic-inorganic composite material is obtained. When the resultant organic-inorganic composite material is subjected to measurement by 1H-NMR, the peak derived from the vinyl group vanishes. Accordingly, it is supposed that in the resultant organic-inorganic composite material, the polymer compound is covalently bonded to the inorganic oxide like a structure illustrated in FIG. 2D.

In addition, a peak measured by Si-NMR for the above-obtained silica gel is compared with a peak measured for the resultant organic-inorganic composite material, whereby the presence of the covalent bond between the polymer compound and the inorganic oxide can be determined.

Incidentally, FIG. 2C and FIG. 2D are typical drawings illustrated for explaining the method for evaluating the presence of the covalent bond. Accordingly, silica in FIG. 2C forms a two-dimensional network structure. However, silica actually obtained has a three-dimensional network structure. The proportion of the sites having the vinyl group bonded to the silica may be more or less than the proportion illustrated in the drawing. In FIG. 2D, polymethyl methacrylate is one-dimensionally illustrated. However, a multifunctional monomer is also impregnated upon the impregnation with methyl methacrylate to conduct polymerization, whereby a polymer compound having a three-dimensional network structure is obtained. The proportion of the covalent bond between the polymer compound and the inorganic oxide may also be more or less than the proportion illustrated in FIG. 2D. The silica has a three-dimensional network structure like that illustrated in FIG. 2C.

One criterion regarding the high transparency and low coefficient of linear expansion of the composite material according to this embodiment is to determine whether phase separation between the organic and inorganic components occurs or not. Since a haze value becomes higher as the occurrence of the phase separation increases, the composite material according to this embodiment has a predetermined haze value.

The haze value of the organic-inorganic composite material according to this embodiment in terms of a thickness of 5 mm is 10% or less. When the haze value is 10% or less, reduction in transmittance by scattering or the like within the composite material is hard to occur, and such a composite material is suitable for use in an optical element. The organic-inorganic composite material according to this embodiment favorably has a haze value of 2% or less, more favorably 1% or less, in terms of a thickness of 5 mm.

The composite material according to this embodiment may contain other components than the above-described components within such a limit as not to impede the transparency and coefficient of linear expansion. Such components include a chain-transfer agent, a silane coupling agent, an antioxidant, an ultraviolet absorbent, an ultraviolet stabilizer, a surfactant, a parting agent, a dye or pigment, and a filler.

Since the composite material according to this embodiment has at least one polymer compound, the composite material can be provided as a composite material having a refractive index distribution by, for example, containing two or more polymer compounds different in refractive index. The polymer compounds used can be suitably controlled such that the refractive index distribution becomes continuous.

The composite material according to this embodiment may have a refractive index distribution therein for use for an optical element such as an optical lens. In order to produce the refractive index distribution, it is necessary that the polymer compounds or inorganic oxides having the three-dimensional network structure have a refractive index distribution. In other words, the compositions of two or more polymer compounds different in refractive index are spatially distributed, thereby providing an organic-inorganic composite material having a refractive index distribution. In the case of letting the polymer compounds have the distribution, there is mentioned a method of letting two or more polymerizable monomers different in refractive index have a compositional distribution to polymerize them. There is also mentioned a method of separately causing the polymerizable monomer to contain low-molecular/high-molecular compounds different in refractive index in advance to give a concentration distribution before the polymerization reaction of the monomer, or a method of giving the concentration distribution while conducting a polymerization reaction with the monomer. There is further mentioned a method of forming a distribution of two or more low-molecular/high-molecular compounds different in refractive index by diffusion, external force or the like and then immobilizing the structure.

In the case of letting the inorganic oxides have the distribution, there is mentioned a method of adding a photo-induced acid generator or photo-induced base generator or the like to partially advance a sol-gel reaction by irradiation of light such as UV. It is possible to conduct a sol-gel reaction by combining another kind of sol-gel reaction precursor in addition to the acid generator to let the inorganic oxides have a compositional distribution. It is also possible to distribute, as a filler, inorganic fine particles of an inorganic oxide or the like of such a size and an amount as not to affect the transparency of an optical element, thereby forming a refractive index distribution.

Besides the examples mentioned above, for example, a method making use of a density difference between (among) the materials making up the composite material is also be mentioned.

Examples of the kind of the refractive index distribution formed in the composite material according to this embodiment include an axial type having a distribution in a direction of an optical axis and a radial type having a distribution in a direction perpendicular to the optical axis. It is generally known that an axial type distributed index lens produces an aberration correction effect equivalent to an aspherical surface by giving a curvature to the surface. On the other hand, it is known that a radial type distributed index lens has a greatest feature in that a medium itself has refracting power, acts as a lens even when both surfaces are plane and has such great aberration correction capability that Petzval's sum and chromatic aberration can be corrected. In this embodiment, the radial type distributed index form having the aberration correction capability is favorable. However, the distribution form is not limited thereto so far as a given designed value is achieved according to use.

Here, the refractive index distribution means that the refractive index exhibits continuous change on a straight line formed by connecting two given points on a surface of the composite material or in a section thereof.

### Second Embodiment

The production process of an organic-inorganic composite material, which is a second embodiment of the present invention, includes the following first and second steps. In the first step, an inorganic oxide having a three-dimensional network structure into which a reactive group has been introduced is provided. In the second step, a reactive compound is polymerized to obtain a polymer compound having a three-dimensional network structure, and the reactive compound is caused to react with the reactive group to covalently bond the polymer compound to the inorganic oxide.

Here, the reactive group means a substituent causing a chemical reaction with the reactive compound to form a covalent bond. Examples of the chemical reaction caused by the reactive group and the reactive compound include polymerization reaction such as polymerizable unsaturated bond-polymerizable unsaturated bond reactions (olefins such as a vinyl group, an allyl group and dienes), epoxy reactions such as epoxy group-carboxylic acid, amine or hydroxyl group reactions, isocyanate reactions such as isocyanate-hydroxyl group, carboxylic acid or amine reactions, esterification reactions of a carboxyl group and a hydroxyl group, and amide esterification reactions of an amine or oxazoline and a carboxylic acid. Besides these reactions, various chemical reactions such as Michael addition reactions and ene-thiol reactions are mentioned. The chemical reaction may be freely selected from the above-mentioned chemical reactions according to the physical properties and reaction mechanism of the reactive group and reactive compound required in this embodiment.

Here, the reactive compound means a polymerizable monomer or a polymer compound containing the above-described reactive groups. The polymerizable monomer is a monomer which will becomes the above-described “polymer compound”. Examples of the polymerizable monomer include the above-mentioned acrylic monomers and styrenic monomers. Examples of the polymer compound containing the reactive group include polymer compounds in which the reactive group is contained in each monomer unit thereof, such as polyhydroxyethyl methacrylate, polyacrylic acid and poly(dimethyl-aminomethylstyrene). In addition, polymer compounds in which the reactive group has been partially introduced into a part of monomer unit(s) thereof, or into a polymer terminal, such as EPOCROS (product of NIPPON SHOKUBAI CO., LTD.), which is an oxazoline-group-containing polymer, POLYMENT (product of NIPPON SHOKUBAI CO., LTD.) being an amino-group-containing polymer, and the ARUFON series (products of TOAGOSEI CO., LTD), which are polymers containing a hydroxyl group, a carboxylic acid or an epoxy group, and so on are mentioned.

Specific examples of an introduction step will hereinafter be mentioned. There are various processed as a process for forming the inorganic oxide having the three-dimensional network structure according to this embodiment. However, the process is favorably conducted by a sol-gel reaction of the reactive-group-containing compound from the viewpoint of introducing the reactive group. In short, in the introduction step, the reactive group is introduced into the inorganic oxide having the three-dimensional network structure by the sol-gel reaction of the reactive-group-containing compound, and the inorganic oxide having the three-dimensional network structure is obtained by a sol-gel reaction of a precursor such as its corresponding alkoxide. In this embodiment, examples of the inorganic oxide include silicon dioxide such as SiO₂, titanium oxides such as TiO₂, zirconium oxides such as ZrO₂ and aluminum oxide such as Al₂O₃. However, the inorganic oxide is favorably SiO₂. Upon this reaction, a predetermined amount of a precursor having a reactive group such as a vinyl group is used, thereby obtaining an inorganic oxide containing the reactive group and having the three-dimensional network structure.

For example, when a vinyl group derived from methacrylic acid is caused to be contained in SiO₂ having the three-dimensional network structure, a predetermined amount of a product obtained by hydrolyzing 3-methacryloxypropyltrimethoxysilane one end of which has been esterified with methacrylic acid in advance is mixed with tetramethoxysilane which is a precursor for sol-gel reaction. When the sol-gel reaction is then conducted by an acid-alkali, a silica containing the vinyl group and having a three-dimensional network structure is obtained. Here, since the hydrolyzing rate of 3-methacryloxypropyltrimethoxy-silane is very slow compared with a tetrafunctional compound such as TMOS or TEOS due to influence by steric hindrance or the like, this silane can be caused to successfully react by hydrolyzing it with a catalyst in advance and then adding TMOS or the like. As described above, when plural kinds of precursors are used in the sol-gel reaction in particular, it is necessary to select a suitable reaction process taking respective hydrolyzing properties and condensing properties into consideration.

Besides the above, there are mentioned various process such as, for example, a process of using as the reactive group an unreacted hydroxyl group contained in the inorganic oxide having the three-dimensional network structure after the sol-gel reaction of SiO₂. However, the present invention is not limited to these processes.

After the inorganic oxide having the three-dimensional network structure, into which the reactive group has been introduced, is provided, a polymer compound having a three-dimensional network structure is obtained, and at the same time the polymer compound is covalently boned to the inorganic oxide. In order to penetrate a reactive compound into the three-dimensional network structure, it is general to use diffusion. Besides this, a method such as replacement with supercritical carbon dioxide is mentioned. The reactive compound is penetrated as described above to react with the reactive group, thereby forming the three-dimensional network structure of the polymer compound and at the same time producing a covalent bond between the polymer compound and the inorganic oxide.

The reactive compound is favorably liquid before the reaction and cured or solidified after the reaction. However, even when the reactive compound is solid before the reaction, it is possible to use it by dissolving it in a solvent or monomer. Even when the reactive compound is liquid after the reaction, it is also possible to cure or solidify it after the reaction by using a compound that can be polymerized or cured in another reaction in combination. In addition, the reactive compound may be used singly, or plural kinds of reactive compounds having the same reactivity may also be mixed and used.

The reactive compound according to this embodiment is used in combination with a multifunctional reactive compound, whereby the three-dimensional network structure can be formed. When the reactive compound is used in combination with a multifunctional monomer, it is considered that the organic three-dimensional network structure is made strong by the multifunctional monomer to bring about the effect to lower the coefficient of linear expansion. Here, the multifunctional monomer means a compound having plural reactive groups in its molecule, and examples thereof include bifunctional or trifunctional polymerizable compounds of the above-described polymerizable compounds and polymer compounds having plural reactive groups in their molecules.

An initiator, a catalyst, a reaction accelerator, etc., which are used in the respective reactions, may be added in advance in the reaction of the reactive group and the reactive compound to react them. At this time, it is also possible to accelerate the reaction by applying external energy such as heat or light. For example, when the reactive group is a polymerizable olefin such as a vinyl group, a publicly known polymerization initiator such as azobisisobutyronitrile (AIBN) or benzoyl peroxide (BPO) may be used. However, the polymerization initiator is not limited thereto.

In the production of the composite material according to this embodiment, other components than the above-described components may be contained within such a limit as not to impede the transparency and coefficient of linear expansion. Such components include a chain-transfer agent, a silane coupling agent, an antioxidant, an ultraviolet absorbent, an ultraviolet stabilizer, a surfactant, a parting agent, a dye or pigment, and a filler.

In the production process of the organic-inorganic composite material according to this embodiment, the step of polymerizing the reactive compound to obtain the polymer compound having the three-dimensional network structure as well as causing the reactive compound to react with the reactive group to covalently bond the polymer compound to the inorganic oxide may be conducted plural times (at least once), so that it is also possible to produce a composite material having compositions of plural polymer compounds and different refractive index distributions derived from the plural polymer compounds. After the step of providing the inorganic oxide having the three-dimensional network structure into which the reactive group has been introduced, the following first and second penetration steps are conducted. In the first penetration step a first reactive compound is caused to penetrate into the inorganic oxide having the three-dimensional network structure, and then in the second penetration step a second reactive compound is caused to penetrate therein. Since the reaction step may be conducted plural times (at least once), it is possible to conduct a first reaction step after the first penetration step and then to conduct the second penetration step followed by a second reaction step. The reaction step may also be conducted only once after completion of the first penetration step and the second penetration step. Third Embodiment

The production process of an organic-inorganic composite material according to a third embodiment of the present invention has a first step of providing an inorganic oxide having a three-dimensional network structure into which a reactive group has been introduced, a second step of causing a reactive compound to react with the reactive group to covalently bond the reactive compound to the inorganic oxide, and a third step of polymerizing the reactive compound to obtain a polymer compound having a three-dimensional network structure.

The third embodiment is the same as the second embodiment except that after the reactive compound is caused to react with the reactive group to covalently bond the reactive compound to the inorganic oxide, the reactive compound is polymerized to obtain the polymer compound having the three-dimensional network structure.

### Fourth Embodiment

The production process of an organic-inorganic composite material according to a fourth embodiment of the present invention has a first step of providing an inorganic oxide having a three-dimensional network structure into which a reactive group has been introduced, a second step of polymerizing a reactive compound to obtain a polymer compound having a three-dimensional network structure, and a third step of causing the reactive compound to react with the reactive group to covalently bond the polymer compound to the inorganic oxide.

The fourth embodiment is the same as the second embodiment except that after the reactive compound is polymerized to obtain the polymer compound having the three-dimensional network structure, the reactive compound is caused to react with the reactive group to covalently bond the polymer compound to the inorganic oxide.

### Fifth Embodiment

A fifth embodiment of the present invention relates to an optical element produced from the organic-inorganic composite material according to the present invention. Since the organic-inorganic composite material according to the present invention has high transparency and a low coefficient of linear expansion, it is suitably used as an optical element such as a lens or optical waveguide. The composite material according to the present invention is cut and polished, whereby it may be worked into an optical element. However, the optical element is more favorably obtained by cast-polymerization with a mold of a desired element shape using a publicly known cast-polymerization process.

Examples of such an optical element include lenses for camera, spectacle lenses, lenses for various optical systems, prisms and optical waveguides. Since the composite material according to this embodiment has a continuous change in refractive index in the material, a distributed refractive index type optical element such as a distributed refractive index lens is obtained according to a working method or a shape of a mold used in the cast-polymerization. The form of this refractive index distribution is controlled to a desired form, whereby it is possible to produce a lens having the same effect as a convex or concave lens even when both surfaces thereof are, for example, planar.

The surface of the optical element according to this embodiment may be covered with an anti-reflection coating. Reflection of light on the surface of the optical element can be inhibited by providing the anti-reflection coating. No particular limitation is imposed on the anti-reflection coating. However, aluminum oxide or the like is mentioned.

### EXAMPLES

The present invention will hereinafter be described more specifically by Examples. However, the present invention is not limited to these Examples. Respective evaluations in the Table, which will be described subsequently, were performed according to the following respective methods.

### Evaluation Methods of Composite Material

### (1) Measurement of Coefficient of Linear Expansion:

Coefficient of linear expansion of an organic-inorganic composite material obtained in each Example was measured in a temperature range of from 20° C. to 60° C. by means of a thermomechanical analyzer (Thermo plus EVO/TMA8310, manufactured by Rigaku Corporation).

### (2) Measurement of Haze Value

A haze value (diffuse transmittance/total light transmittance×100) of a sample having a thickness of 5 mm was measured according to the measuring method shown in Method for Determining Haze Value for Plastic Transparent Material (JIS-K 7136, ISO 14782).

### Example 1

A gel which will become a base was prepared in the following manner. After 10 parts by mass of 3-methacryloxypropyltrimethoxysilane (KBM-503, product of Shin-Etsu Chemical Co., Ltd.), 10 parts by mass of ethanol and 1 part by mass of 0.1N aqueous ammonia were first mixed, the resultant mixture was stationarily left for 2 hours or more. After 100 parts by mass of 1N hydrochloric acid was then added and mixed, a mixture of 90 parts by mass of ethanol and 90 parts by mass of tetramethoxysilane (TMOS) was added and the resultant mixture was well stirred. This solution was placed in a disk-shape mold (20 mm in diameter, 5 mm in thickness) and heated to cause gelling at 60° C. to obtain a gelatinous material.

The resultant gel was taken out of the mold and immersed in a methyl methacrylate (MMA) reaction liquid (a mixture of 90 parts by mass of MMA, 10 parts by mass of trimethylolpropane triacrylate (TMPTA) and 1 part by mass of azobisisobutyronitrile (AIBN)) to completely replace the solvent in the gel.

The resultant gel was set in a columnar cell for cast-polymerization, the upper and lower surfaces of which were formed of quartz glass, voids were filled with the MMA reaction liquid, and a polymerization reaction was then conducted at 60° C. Incidentally, the columnar cell for cast-polymerization had an inner diameter of 50 mm and a height of 5 mm. After completion of the polymerization reaction, the gel was taken out of the cell, and the resin around the gel was cut and removed to obtain a composite material molded into a columnar form.

With respect to the evaluated results of the composite material, the average value of coefficients of linear expansion (CTE) was 54 ppm/K. Its appearance was colorless and transparent, and the haze value was 0.6%. The covalent bond between the polymer compound and the inorganic oxide was identified by 1H-NMR measurement. In short, when the gelatinous material was subjected to measurement by means of 1H-NMR, a peak derived from a vinyl group was observed, while the peak derived from the vinyl group vanished in the composite material finally obtained. The reason for this is supposed to be that the vinyl group of the silica derivative making up the gelatinous material was polymerized with the vinyl group of the polymerizable compound. Accordingly, it is considered that the polymer compound is covalently bonded to the inorganic oxide. Incidentally, the results are shown in Table 1.

### Example 2

A composite material was obtained in exactly the same manner as in Example 1 except that a gel which will become a base was prepared by using 25 parts by mass of KBM-503/25 parts by mass of ethanol and 75 parts by mass of TMOS/75 parts by mass of ethanol. The average value of CTE was 48 ppm/K, the appearance was colorless and transparent, and the haze value was 0.6%. The covalent bond between the polymer compound and the inorganic oxide was identified by 1H-NMR measurement like Example 1. It is considered for the same reason as in Example 1 that the polymer compound is covalently bonded to the inorganic oxide. The results are shown in Table 1.

### Example 3

The same as that used in Example 1 was used as the gel which will become the base. The gel was first immersed in a benzyl methacrylate (BzMA) reaction liquid (a mixture of 90 parts by mass of BzMA, 10 parts by mass of TMPTA and 1 part by mass of AIBN) to completely replace the solvent in the gel. The gel replaced by BzMA was then set in the same cell for cast-polymerization as in Example 1, voids were filled with a MMA reaction liquid, the gel was stationarily left for 1 hour, and a polymerization reaction was then conducted at 60° C. to obtain a composite material. Since the same refractive index distribution as a convex lens was visually confirmed in this sample, the both surfaces thereof were subjected to specularly polishing work to measure its refractive index distribution by a refractive index distribution measuring apparatus (PAC-5C, manufactured by ADVANCED TECHNOLOGIES CO., LTD.). As a result, the refractive index difference Δn between the center and the periphery was 0.03, and it was identified that the composite material has a convex type refractive index distribution. The average value of CTE was 55 ppm/K, the appearance was colorless and transparent, and the haze value was 0.7%. It is also considered for the same reason as in Example 1 from the result of measurement by 1H-NMR that the polymer compound is covalently bonded to the inorganic oxide. The results are shown in Table 1.

### Example 4

A composite material molded into a columnar form was obtained in the same manner as in Example 3 except that the reaction liquid in which the gel was first immersed was changed to a styrene (St) reaction liquid (90 parts by mass of St, 10 parts by mass of TMPTA and 1 part by mass of AIBN), the reaction liquid with which voids within the cell were filled was changed to a trifluoroethyl methacrylate (3FMA) reaction liquid (120 parts by mass of 3FMA, 10 parts by mass of TMPTA and 1 part by mass of AIBN), and the time for being stationarily left within the cell was changed to 2 hours. Since the same refractive index distribution as a convex lens could be visually confirmed in this sample, the Δn was measured like Example 3. As a result, the Δn was 0.10, and it was identified that the composite material has a convex type refractive index distribution.

The average value of CTE was 54 ppm/K, the appearance was colorless and transparent, and the haze value was 0.6%. It is also considered for the same reason as in Example 1 from the result of measurement by 1H-NMR that the polymer compound is covalently bonded to the inorganic oxide. The results are shown in Table 1.

### Example 5

A composite material molded into a columnar form was obtained in the same manner as in Example 4 except that the reaction liquid in which the gel was first immersed was changed to a St-BzMA reaction liquid (45 parts by mass of St, 45 parts by mass of BzMA, 10 parts by mass of TMPTA and 1 part by mass of AIBN). Since the same refractive index distribution as a convex lens could be visually confirmed in this sample, the Δn was measured like Example 3. As a result, the Δn was 0.08, and it was identified that the composite material has a convex type refractive index distribution.

The average value of CTE was 56 ppm/K, the appearance was colorless and transparent, and the haze value was 1.8%. It is also considered for the same reason as in Example 1 from the result of measurement by 1H-NMR that the polymer compound is covalently bonded to the inorganic oxide. The results are shown in Table 1.

### Example 6

A gel which will become a base was prepared in the following manner. After 10 parts by mass of 3-glycidoxypropyltrimethoxysilane (LS-2940, product of Shin-Etsu Chemical Co., Ltd.), 10 parts by mass of ethanol and 1 part by mass of a 0.1N aqueous solution of sodium hydroxide were first mixed, the resultant mixture was stationarily left for 2 hours or more. After 90 parts by mass of pure water and 10 parts by mass of a 0.01N aqueous solution of sodium hydroxide were then added and mixed, a mixture of 90 parts by mass of ethanol and 90 parts by mass of TMOS was added and the resultant mixture was well stirred. This solution was placed in a disk-shape mold (20 mm in diameter, 5 mm in thickness) and left to stand to gelling at room temperature (23° C.), thereby obtaining a gelatinous material. The resultant gel was taken out of the mold and immersed in a reaction liquid (a mixed solution of 70 parts by mass of MMA, 10 parts by mass of glycidyl methacrylate (GMA), 10 parts by mass of trimethylolpropane triacrylate (TMPTA), 0.1 parts by mass of IRGACURE 184 (product of Ciba Speciality Chemicals Corporation) and 0.1 parts by mass of IRGACURE 250 (product of Ciba Speciality Chemicals Corporation) to completely replace the solvent in the gel.

The resultant gel was set in a columnar cell for cast-polymerization, the upper and lower surfaces of which were formed of quartz glass, voids were filled with the reaction liquid, and a polymerization reaction was then conducted to cause curing by irradiating the cell for cast-polymerization with radiation according to a publicly known photopolymerization process. Incidentally, the columnar cell for cast-polymerization had an inner diameter of 50 mm and a height of 5 mm. As a source for irradiation of the radiation, was used an UV light source EX250 (manufactured by HOYA CANDEO OPTRONICS CORPORATION) equipped with an ultrahigh pressure mercury lamp of 250 W. An ultraviolet-light-transmitting, visible-light-absorbing filter (UTVAF-50S-36U) and a frost-type diffuser panel (DFSQ1-50C02-800) (both, manufactured by SIGMA KOKI CO., LTD.) were arranged between the light source and the cell for cast-polymerization to irradiate the cell for cast-polymerization with the radiation from the light source. The illuminance on the quartz glass surface of the cell for cast-polymerization on the irradiated side was 30 mW/cm² at a wavelength of 365 nm.

After completion of the polymerization reaction, the gel was taken out of the cell, and the resin around the gel was cut and removed to obtain a composite material. The average value of CTE was 53 ppm/K, the appearance was colorless and transparent, and the haze value was 0.9%. The covalent bond between the polymer compound and the inorganic oxide was identified by 1H-NMR measurement like Example 1. It is also considered for the same reason as in Example 1 from the result of the measurement by 1H-NMR that the polymer compound is covalently bonded to the inorganic oxide. The results are shown in Table 1.

### Example 7

An alumina gel which will become a base was prepared in the following manner. After 100 parts by mass of 3-methacryloxypropyltrimethoxysilane (KBM-503, product of Shin-Etsu Chemical Co., Ltd.), 50 parts by mass of ethanol and 1 part by mass of 0.1N aqueous ammonia were first mixed, the resultant mixture was stationarily left for 10 hours or more. Then, 0.1 parts by mass of 1N hydrochloric acid were added to neutralize the mixture to obtain silica sol.

The alumina sol was then prepared in the following manner. Fifty parts by mass of ethyl oxobutanoate and 200 parts by mass of 2-ethylbutanol were first mixed, and 100 parts by mass of aluminum sec-butoxide were added thereto and the resultant mixture was well stirred. A mixed solution of 135 parts by mass of 2-ethylbutanol, 15 parts by mass of 1-ethoxy-2-propanol and 1 part by mass of 0.01N hydrochloric acid was gradually added dropwise to this solution and the resultant mixture was well stirred. Thereafter, the mixture was heated for 2 hours at 110° C. and filtered through a filter having a pore size of 0.45 μm to obtain an alumina sol.

Fifteen parts by mass of the silica sol were gradually added dropwise to 500 parts by mass of this alumina sol and the resultant mixture was well stirred. This solution was placed in a disk-shape mold (20 mm in diameter, 5 mm in thickness), and the solvent was slowly volatilized at room temperature (23° C.) to obtain a gelatinous material.

The resultant gel was taken out of the mold and immersed in a methyl methacrylate (MMA) reaction liquid (a mixture of 90 parts by mass of MMA, 10 parts by mass of trimethylolpropane triacrylate (TMPTA) and 1 part by mass of azobisisobutyronitrile (AIBN)) to completely replace the solvent in the gel.

Thereafter, polymerization was conducted under the same conditions as in Example 1 to obtain a composite material. The average value of CTE was 55 ppm/K, the appearance was colorless and transparent, and the haze value was 1.0%. The covalent bond between the polymer compound and the inorganic oxide was identified by 1H-NMR measurement like Example 1. It is also considered for the same reason as in Example 1 from the result of the measurement by 1H-NMR that the polymer compound is covalently bonded to the inorganic oxide. The results are shown in Table 1.

### Comparative Example 1

A composite material was obtained in exactly the same manner as in Example 1 except that gel which will become a base was prepared by using 100 parts by mass of TMOS, 100 parts by mass of ethanol and 100 parts by mass of 1N hydrochloric acid. The average value of CTE was 64 ppm/K, the appearance was colorless and transparent, and the haze value was 0.6%. The results are shown in Table 1.

### Comparative Example 2

A composite material was obtained in exactly the same manner as in Example 3 except that the same gel as that used in Comparative Example 1 was used as the gel which will become a base. Since the same refractive index distribution as a convex lens could be visually confirmed in this sample, the Δn was measured like Example 3. As a result, the Δn was 0.03, and it was identified that the composite material has a convex type refractive index distribution. The average value of CTE was 66 ppm/K, the appearance was colorless and transparent, and the haze value was 0.7%. The results are shown in Table 1.

### Comparative Example 3

A comparative investigation was conducted with reference to Japanese Patent Application Laid-Open No. 05-086191. A stirring rod with a motor, 300-ml and 100-ml dropping funnels with a pressure equalizer and a condenser tube with a three way cock were installed in a 1-L four-necked flask, and the interior of the system was purged with nitrogen.

The flask was charged with 50 ml of isopropanol and 10 ml of a 0.3N aqueous solution of HCl. The 300-ml dropping funnel with the pressure equalizer was charged with a solution with 200 g of ethyl silicate 40 (product of COLCOAT CO., LTD.) dissolved in 80 ml of absolute isopropanol. The 100-ml dropping funnel with the pressure equalizer was charged with a monomer solution with 12.8 g of n-butyl acrylate (BA), 10.0 g of methyl methacrylate (MMA), 2.1 g of neopentylglycol diacrylate (NPGDA), 1.0 g of 2,2′-azobis[2-(2-imidazolin-2-yl)propane] and 0.5 g of dodecylmercaptan dissolved in 50 ml of isopropanol. The flask was then heated to 70° C. under nitrogen atmosphere. The respective solutions were added dropwise at the same time over 2 hours from both dropping funnels. After completion of the dropping, 0.2 g of 2,2′-azobis[2-(2-imidazolin-2-yl)propane] was added to conduct refluxing for 2 hours, and then the reaction was completed.

The resultant reaction solution was whitely turbid, and the reaction was conducted again under the same conditions. However, a whitely turbid reaction solution was obtained in either reaction. The reaction solution was cast in a mold made of Teflon (trademark) and dried to obtain a white specimen.

For evaluation, the specimen was worked into a size of 20 mm in diameter and 5 mm in thickness, and both surfaces thereof were subjected to specularly polishing work. The evaluated results were such that the average value of CTE was 80 ppm/K, the appearance was white and somewhat uneven, and the haze value was 92%. The reason why the haze value becomes high as described above is considered to be that an organic-inorganic composite material in which polymethyl methacrylate (PMMA) and silica gel were macroscopically phase-separated was obtained.

TABLE 1

| | Ex. 1 | Ex. 2 | Ex. 3 | Ex. 4 | Ex. 5 | Ex. 6 |
|---|---|---|---|---|---|---|
| Polymer | MMA/TMPTA | MMA/TMPTA | BzMA/TMPTA | St/TMPTA | St/BzMA/TMPTA | MMA/GMA/TMPTA |
| compound | | | MMA/TMPTA | 3FMA/TMPTA | 3FMA/TMPTA | |
| Inorganic | SiO₂ | SiO₂ | SiO₂ | SiO₂ | SiO₂ | SiO₂ |
| oxide | | | | | | |
| Presence of | YES | YES | YES | YES | YES | YES |
| organic- | | | | | | |
| inorganic | | | | | | |
| bond | | | | | | |
| CTE | 54 | 48 | 55 | 54 | 56 | 53 |
| (ppm/K) | | | | | | |
| Haze (%) | 0.6 | 0.6 | 0.7 | 0.6 | 1.8 | 0.9 |
| Appearance | Colorless | Colorless | Colorless | Colorless | Colorless | Colorless |
| | and | and | and | and | and | and |
| | transparent | transparent | transparent | transparent | transparent | transparent |

| | | Comp. | Comp. | Comp. |
|---|---|---|---|---|
| | Ex. 7 | Ex. 1 | Ex. 2 | Ex. 3 |
| Polymer | MMA/TMPTA | MMA/TMPTA | BzMA/TMPTA | BA/MMA/NPGDA |
| compound | | | MMA/TMPTA | |
| Inorganic | Al₂O₃/SiO₂ | SiO₂ | SiO₂ | SiO₂ |
| oxide | | | | |
| Presence of | YES | NO | NO | NO |
| organic- | | | | |
| inorganic | | | | |
| bond | | | | |
| CTE | 55 | 64 | 66 | 80 |
| (ppm/K) | | | | |
| Haze (%) | 1 | 0.6 | 0.7 | 92 |
| Appearance | Colorless | Colorless | Colorless | White |
| | and | and | and | |
| | transparent | transparent | transparent | |

Incidentally, “Presence of organic-inorganic bond” in Table means the presence of a covalent bond between the polymer compound and the inorganic oxide.

As apparent from Table 1, an organic-inorganic composite material having a high transparency and a low coefficient of linear expansion sufficient for an optical element can be obtained when a covalent bond exists between the polymer compound having the three-dimensional network structure and the inorganic oxide having the three-dimensional network structure.

### INDUSTRIAL APPLICABILITY

The organic-inorganic composite material obtained by the present invention can be advantageously utilized for various optical elements, for example, various lenses such as camera lenses, spectacle lenses and micro lenses, optical waveguides, and various optical films and sheets such as functional films and sheets, anti-reflection coatings and optical multi-layer films.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-006249, filed Jan. 14, 2010, which is hereby incorporated by reference herein in its entirety.

1. An organic-inorganic composite material comprising at least one polymer compound and at least one inorganic oxide having a three-dimensional network structure, wherein the polymer compound has a three-dimensional network structure and is covalently bonded to the inorganic oxide, and the haze value of the organic-inorganic composite material in terms of a thickness of 5 mm is 10% or less.

2. The organic-inorganic composite material according to claim 1, wherein said at least one polymer compound is a vinyl polymer compound.

3. The organic-inorganic composite material according to claim 1, wherein the inorganic oxide is at least one inorganic oxide selected from the group consisting of silicon dioxide, titanium oxide, aluminum oxide and zirconium oxide.

4. The organic-inorganic composite material according to claim 1, wherein the polymer compound is two polymer compounds different in refractive index, and the compositions of the two polymer compounds are spatially distributed, thereby having a refractive index distribution.

5. An optical element comprising the organic-inorganic composite material according to claim 1 and an anti-reflection coating covering a surface of the organic-inorganic composite material.

6. A production process of an organic-inorganic composite material, comprising a first step of providing an inorganic oxide having a three-dimensional network structure into which a reactive group has been introduced and a second step of polymerizing a reactive compound to obtain a polymer compound having a three-dimensional network structure as well as causing the reactive compound to react with the reactive group to covalently bond the polymer compound to the inorganic oxide.

7. A production process of an organic-inorganic composite material, comprising a first step of providing an inorganic oxide having a three-dimensional network structure into which a reactive group has been introduced, a second step of causing a reactive compound to react with the reactive group to covalently bond the reactive compound to the inorganic oxide, and a third step of polymerizing the reactive compound to obtain a polymer compound having a three-dimensional network structure.

8. A production process of an organic-inorganic composite material, comprising a first step of providing an inorganic oxide having a three-dimensional network structure into which a reactive group has been introduced, a second step of polymerizing a reactive compound to obtain a polymer compound having a three-dimensional network structure, and a third step of causing the reactive compound to react with the reactive group to covalently bond the polymer compound to the inorganic oxide.

9. The production process of the organic-inorganic composite material according to claim 6, wherein the reactive compound has at least a multifunctional monomer.

10. The production process of the organic-inorganic composite material according to claim 6, wherein the first step is conducted by a sol-gel reaction of a compound containing the reactive group.

11. The production process of the organic-inorganic composite material according to claim 6, wherein the reactive group is a vinyl group.
